(19) United States
(12) Patent Application Publication
(10) Pub. No.: US 2019/0353924 A1
(43) Pub. Date: Nov. 21, 2019

(54) SPECTACLES AND HINGE ASSEMBLY THEREOF

(71) Applicant: EYE-BIZ Eyewear (Shenzhen) Limited, Shenzhen (CN)

(72) Inventors: Andong ZHANG, Shenzhen (CN); Wah Kiang YANG, Shenzhen (CN)

(73) Assignee: EYE-BIZ Eyewear (Shenzhen) Limited, Shenzhen (CN)

(21) Appl. No.: 16/412,690

(22) Filed: May 15, 2019

(30) Foreign Application Priority Data
May 16, 2018 (CN) CN 201820724467.4

(51) Int. Cl. G02C 5/22

(52) U.S. Cl. CPC G02C 5/22

(57) ABSTRACT

Spectacles and a hinge assembly thereof are provided. A hinge assembly includes a first connecting portion, a reinforcing portion, and a second connecting portion. The first connecting portion has a recessed structure. The reinforcing portion at least partially covers an inner wall of the recessed structure, and a strength of a material of the reinforcing portion is greater than a strength of a material of the first connecting portion. The second connecting portion is inserted into the recessed structure and is rotatable with respect to the first connecting portion.

### CROSS REFERENCE TO RELATED APPLICATION

This application claims the benefit of Chinese Patent Application No. 2018207244674, entitled “SPECTACLES AND HINGE ASSEMBLY THEREOF” filed on May 16, 2018, the entire content of which is incorporated herein in its entirety.

### TECHNICAL FIELD

The present disclosure relates to the technical field of spectacles, and in particular to hinge assemblies and spectacles.

### BACKGROUND

Spectacles, such as myopia glasses, hyperopia glasses, presbyopia glasses and sunglasses, are commonly used in daily use. A frame and arms are typically connected by a hinge assembly that is susceptible to damage during daily use of the spectacles. In particular, the hinge assembly of the spectacles is more susceptible to damage when the spectacles are used by lively and naughty children.

### SUMMARY

According to various embodiments of the present disclosure, a hinge assembly and spectacles having the same are provided.

A hinge assembly includes a first connecting portion provided with a recessed structure, a reinforcing portion at least partially covering an inner wall of the recessed structure, and a second connecting portion inserted into the recessed structure and rotatable with respect to the first connecting portion. A strength of a material of the reinforcing portion is greater than a strength of a material of the first connecting portion.

Spectacles includes a frame, an arm, and the aforementioned hinge assembly. The hinge assembly connects the frame and the arm.

The above and other features of the present disclosure including various novel details of construction and combinations of parts, and other advantages, will now be more particularly described with reference to the accompanying drawings and pointed out in the claims.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a partial exploded view of spectacles according to an embodiment.

FIG. 2 is a schematic view of a first connecting portion of FIG. 1 connected to a frame.

FIG. 3 is a schematic view of a reinforcing portion of FIG. 1.

FIG. 4 is a schematic view of an inner core of a second connecting portion of FIG. 1.

### DETAILED DESCRIPTION OF THE EMBODIMENTS

Embodiments of the present disclosure are described more fully hereinafter with reference to the accompanying drawings. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

It will be understood that when an element is referred to as being “fixed” to another element, it can be directly fixed to the other element or intervening elements may be present. Also, when an element is referred to as being “connected” or “coupled” to another element, it can be directly connected or coupled to the other element or intervening elements may be present. As used herein, the terms “vertical”, “horizontal”, “left”, “right” and the like are merely for the illustrative purpose.

Unless otherwise defined, all terms (including technical and scientific terms) used herein have the same meaning as commonly understood by one of ordinary skill in the art to which this invention belongs. The terms used herein is for the purpose of describing particular embodiments only and is not intended to limit the present disclosure. As used herein, the term “and/or” includes any and all combinations of one or more of the associated listed items.

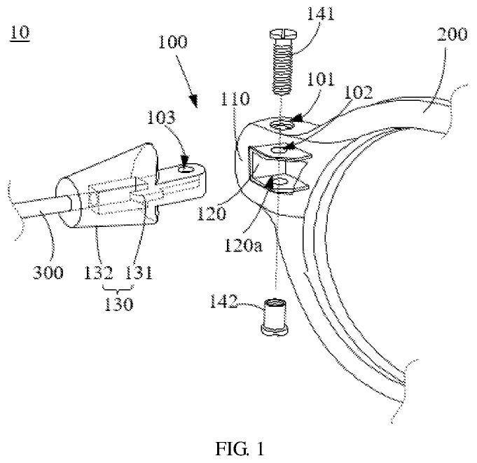

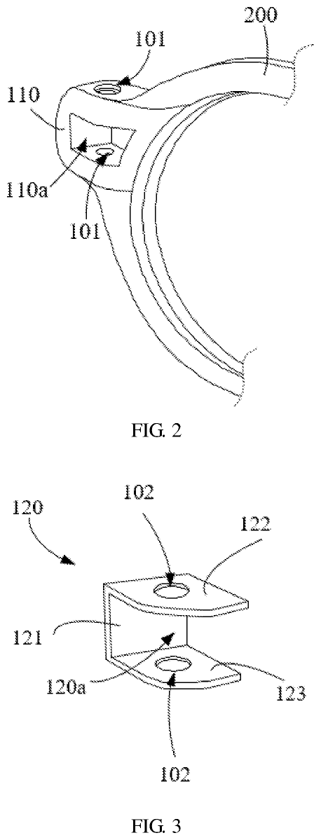

Referring to FIG. 1 and FIG. 3, a hinge assembly 100 according to an embodiment is used to connect a frame 200 and an arm 300, such that the frame 200 and the arm 300 can rotate with respect to each other to facilitate wearing and storage of spectacles 10. The hinge assembly 100 includes a first connecting portion 110, a reinforcing portion 120, and a second connecting portion 130. The first connecting portion 110 is provided with a recessed structure 110a. The reinforcing portion 120 at least partially covers an inner wall of the recessed structure 110a. A strength of a material of the reinforcing portion 120 is greater than a strength of a material of the first connecting portion 110. The second connecting portion 130 is inserted into the recessed structure 110a and is rotatable with respect to the first connecting portion 110.

Specifically, the first connecting portion 110 may be connected to the frame 200, and the second connecting portion 130 may be connected to the arm 300. Alternatively, the first connecting portion 110 may be connected to the arm 300, and the second connecting portion 130 may be connected to the frame 200. The first connecting portion 110 is used as a knuckle of the hinge assembly 100. The second connecting portion 130 is used as a leaf of the hinge assembly 100.

The recessed structure 110a may be a structure such as a through hole, a groove, or the like. The inner wall of the recessed structure 110a is at least partially covered by the reinforcing portion 120. Taking the recessed structure 110a being a groove as an example, the reinforcing portion 120 may only cover the bottom wall or the side walls of the groove, or may cover all of the inner walls of the groove. The reinforcing portion 120 adapted to the recessed structure 110a may be placed in the recessed structure 110a, such that the reinforcing portion 120 can cover the inner walls of the recessed structure 110a. Alternatively, the reinforcing portion 120 can be adhered to the inner wall of the recessed structure 110a with glue.

The second connecting portion 130 is inserted into the recessed structure 110a. Specifically, the second connecting portion 130 is inserted into the recessed structure 110a and is adapted to the recessed structure 110a. Since the reinforcing portion 120 covers the inner wall of the recessed structure 110a, when the second connecting portion 130 is rotated with respect to the first connecting portion 110, a portion of the second connecting portion 130 inserted into the recessed structure 110a is in contact with the reinforcing portion 120. When the second connecting portion 130 is rotated with respect to the first connecting portion 110, the portion of the second connecting portion 130 inserted into the recessed structure 110a is rotated with respect to the first connecting portion 110, and the portion of the second connecting portion 130 inserted into the recessed structure 110a and the reinforcing portion 120 rub against each other, thereby reducing or avoiding direct friction between the second connecting portion 130 and the first connecting portion 110. The reinforcing portion 120 which is more friction-resistant than the first connecting portion 110 is used, such that the hinge assembly 100 is more wear-resistant. For example, the reinforcing portion 120 is made of a metal material, and the first connecting portion 110 is made of a plastic material.

Specifically, the material of the reinforcing portion 120 may be a metal material such as stainless steel or copper alloy, or may be a thermosetting plastic material or the like. The first connecting portion 110 may be made of a material such as plastic, resin, wood, or the like. The strength of the material of the reinforcing portion 120 is greater than the strength of the material of the first connecting portion 110, and the reinforcing portion 120 covers the inner wall of the recessed structure 110a, such that the reinforcing portion 120 reinforces the first connecting portion 110. For example, if the spectacles 10 are impacted or dropped, the spectacles 10 are subjected to external forces, and the reinforcing portion 120 can absorb and disperse destructive forces such as tension, torque, pressure, and the like on the hinge assembly 100, such that the first connecting portion 110 is not easily damaged. In addition, the first connecting portion 110 is made of a material such as wood, plastic, or the like, such that the appearance of the spectacles 10 is beautiful, and demands of users for the appearance and the strength of the hinge assembly 100 are both satisfied.

The aforementioned hinge assembly 100 connects the frame 200 and the arm 300, such that the frame 200 and the arm 300 can be rotated with respect to each other by the rotation of the second connecting portion 130 with respect to the first connecting portion 110. The reinforcing portion 120 covers the inner wall of the recessed structure 110a of the first connecting portion 110, and the strength of the material of the reinforcing portion 120 is greater than the strength of the material of the first connecting portion 110, such that the reinforcing portion 120 can absorb and disperse destructive forces such as tensile, torque, pressure, and the like on the hinge assembly 100 when the spectacles 10 are damaged by external forces. Therefore, the first connecting portion 110 is not easily damaged, and the overall strength of the hinge assembly 100 is improved.

Referring to FIG. 1 and FIG. 3, in one of the embodiments, the reinforcing portion 120 includes a first portion 121, a second portion 122, and a third portion 123. The second portion 122 and the third portion 123 are fixed to the first portion 121, respectively, and the second portion 122 and the third portion 123 are opposite to each other. Therefore, the first portion 121, the second portion 122, and the third portion 123 form a U-shaped member, and the first portion 121, the second portion 122, and the third portion 123 cooperatively form a first groove 120a. The first portion 121, the second portion 122, and the third portion 123 all cover the inner walls of the recessed structure 110a.

Specifically, the first portion 121, the second portion 122, and the third portion 123 may be integrally formed to facilitate connection and fastening between the first portion 121, the second portion 122, and the third portion 123. Referring to FIG. 2, in the illustrated embodiment, the recessed structure 110a is a through hole extending through the first connecting portion 110. The first portion 121, the second portion 122, and the third portion 123 cover one inner wall of the through hole, respectively. Since the second portion 122 is opposite to the third portion 123, the inner wall of the through hole covered by the second portion 122 and the inner wall of the through hole covered by the third portion 123 are opposite to each other. The inner wall of the through hole covered by the first portion 121 is connected to the inner wall of the through hole covered by the second portion 122 and the inner wall of the through hole covered by the third portion 123, respectively.

The second connecting portion 130 is inserted into the first groove 120a and is adapted to the first groove 120a. The second connecting portion 130 is rotatable with respect to the reinforcing portion 120 about an axis of rotation perpendicular to a side wall of the first groove 120a. Specifically, when the second connecting portion 130 is inserted into the first groove 120a, an upper surface of a portion of the second connecting portion 130 inserted into the first groove 120a is in contact with an inner surface of the second portion 122, and a lower surface of a portion of the second connecting portion 130 inserted into the first groove 120a is in contact with an inner surface of the third portion 123. The inner surface of the second portion 122 and the inner surface of the third portion 123 are two side walls of the first groove 120a opposite to each other. Since the reinforcing portion 120 is placed in the recessed structure 110a and is adapted to the recessed structure 110a, when the second connecting portion 130 is rotated with respect to the reinforcing portion 120 about the axis of rotation perpendicular to the side wall of the first groove 120a, the second connecting portion 130 is rotated with respect to the first connecting portion 110. When the spectacles 10 are subjected to external forces, the first portion 121 may absorb and disperse forces from the side of the first connecting portion 110, the second portion 122 may absorb and disperse forces from above the first connecting portion 110, and the third portion 123 may absorb and disperse forces from below the first connecting portion 110. In other words, the reinforcing portion 120 comprehensively reinforces the first connecting portion 110 from various directions, such that the first connecting portion 110 is not easily damaged.

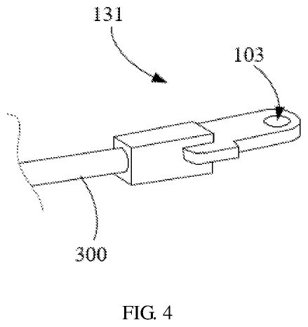

Referring to FIG. 1 and FIG. 4, in one of the embodiments, the second connecting portion 130 includes an inner core 131 and a coating layer 132 covering the inner core 131. A strength of a material of the inner core 131 is greater than a strength of a material of the coating layer 132.

The material used for the coating layer 132 may be plastic or the like. The coating layer 132 may be made of a material such as plastic, wood, or the like, such that the spectacles 10 can be more aesthetically pleasing. Specifically, the material used for the inner core 131 may be a metal material such as a magnesium aluminum alloy or a titanium alloy, and the inner core 131 has high strength, such that the strength of the second connecting portion 130 can be ensured. The inner core 131 may also be made of a material such as plastic, as long as the inner core 131 has a strength greater than that of the coating layer 132. For example, the coating layer 132 is made of plastic, the inner core 131 is made of metal, and the inner core 131 may be covered by the coating layer 131 by injection molding.

In one of the embodiments, the strength of the material of the reinforcing portion 120 is greater than a strength of a material of a surface of the second connecting portion 130.

Specifically, the material of the second connecting portion 130 may be pure plastic, pure wood, or the like. The second connecting portion 130 may also use the inner core 131 having a higher strength, and the coating layer 132 which may be made of plastic, wood, resin, or the like. Since the strength of the material of the reinforcing portion 120 is greater than the strength of the material of the surface of the second connecting portion 130, the reinforcing portion 120 can resist, absorb, and disperse forces from the second connecting portion 130, thereby protecting the first connecting portion 110.

In addition, the surface of the second connecting portion 130 is made of plastic, and the reinforcing portion 120 is made of metal. Due to the damping effect of the plastic, the reinforcing portion 120 and the second connecting portion 130 have a relatively strong friction force therebetween, such that these two are not easily loosened. Moreover, the surface of the metal is smooth, such that the rotation of the second connecting portion 130 with respect to the reinforcing portion 120 is more easier.

Referring to FIG. 1 to FIG. 4, in one of the embodiments, a first hole 101 is provided on the inner wall of the recessed structure 110a, a second hole 102 is provided on the reinforcing portion 120, and a third hole 103 is provided on the second connecting portion 130. The first hole 101, the second hole 102, and the third hole 103 are aligned. The hinge assembly 100 further includes a rotary connecting member, which is engaged with the first hole 101, the second hole 102, and the third hole 103, respectively, such that the second connecting portion 130 can rotate about the rotary connecting member.

Specifically, referring to FIG. 1, the rotary connecting member may be a threaded connecting member. In the illustrated embodiment, the rotary connecting member includes a screw 141 and a nut 142. The first hole 101, the second hole 102, and the third hole 103 are all threaded holes. When the hinge assembly 100 is assembled, the screw 141 sequentially passes through the first hole 101, the second hole 102, and the third hole 103, and is assembled with the nut 142, such that the second connecting portion 130 can rotate with respect to the first connecting portion 110 about the screw 141, thereby driving the arm 300 and the frame 200 to rotate with respect to each other.

In alternative embodiments, the rotary connecting member may also be a pin, and the first hole 101, the second hole 102, and the third hole 103 may be pin holes.

Referring to FIG. 1, a pair of spectacles 10 according to an embodiment is also provided, which includes a frame 200, an arm 300, and the aforementioned hinge assembly 100. The hinge assembly 100 connects the frame 200 and the arm 300.

In the aforementioned spectacles 10, the hinge assembly 100 connects the frame 200 and the arm 300, such that the frame 200 and the arm 300 can be rotated with respect to each other by the relative rotation of the first connecting portion 110 and the second connecting portion 130. The reinforcing portion 120 covers the inner wall of the recessed structure 110a of the first connecting portion 110, and the strength of the material of the reinforcing portion 120 is greater than the strength of the material of the first connecting portion 110, such that the reinforcing portion 120 can absorb and disperse destructive forces such as tensile, torque, and pressure on the hinge assembly 100 when the spectacles 10 are damaged by external forces. Therefore, the first connecting portion 110 is not easily damaged, and the overall strength of the hinge assembly 100 is improved.

In one of the embodiments, the first connecting portion 110 is integrally formed with the frame 200. Specifically, the first connecting portion 110 and the frame 200 may be integrally formed by injection molding, stamping molding, integral milling, and the like, such that the first connecting portion 110 is fastened to the frame 200, and the producing procedure is simplified.

In alternative embodiments, the first connecting portion 110 may also be detachably connected to the frame 200. After the spectacles 10 are used for a period of time, the frame 200 or the hinge assembly 100 need to be replaced due to wear or damage or the like. Due to the detachable connection between the first connecting portion 110 and the frame 200, the replacement of the frame 200 or the first connecting portion 110 is facilitated. Specifically, the first connecting portion 110 and the frame 200 may be connected by a snap connection, a screw connection, or the like.

In one of the embodiments, the second connecting portion 130 is provided with a receiving chamber, and one end of the arm 300 is located in the receiving chamber and an inner wall of the receiving chamber presses against the arm 300.

Specifically, in the process of manufacturing the spectacles 10, for example, a through hole or blind hole may be provided on the second connecting portion 130, and the through hole or blind hole forms the receiving chamber. One end of the arm 300 is then inserted into the receiving chamber. The inner wall of the receiving chamber is tightly attached to the surface of the arm 300 by pressing, for example, by an oil hydraulic press, such that the second connecting portion 130 is fastened to the arm 300.

In addition, the receiving chamber is provided on the inner core 131. The coating layer 132 covers at least a portion of the arm 300. Illustratively, in the process of manufacturing the spectacles 10, a metal sheet may be formed first, and then the metal sheet is tightly coated on one end of the arm 300 and the metal sheet and the arm 300 are both pressed tightly, such that the inner surface of the metal sheet is in close contact with the surface of the arm 300 to form a metal shell holding the arm 300, and the inner core 131 is fastened to the arm 300. The space in the metal shell for receiving the arm 300 is the receiving chamber. As shown in FIG. 1, the coating layer 132 covers the surface of the inner core 131. The coating layer 132 extends from the surface of the inner core 131 to the surface of the arm 300, and the coating layer 132 covers a portion of the surface of the arm 300, such that the coating layer 132 can protect the connecting portion between the arm 300 and the inner core 131 and reinforce the connecting strength therebetween, and prevent the arm 300 from being bent or twisted at the connecting portion between the arm 300 and the inner core 131.

In alternative embodiments, the second connecting portion 130 is integrally formed with the arm 300. Specifically, the second connecting portion 130 and the arm 300 may be integrally formed by injection molding, stamping molding, integral milling, and the like, such that the second connecting portion 130 is fastened to the arm 300, and the producing procedure is simplified. For example, the inner core 131 of the second connecting portion 130 is made of the same material as that of the arm 300, for example, metal such as aluminum-magnesium alloy, titanium alloy, and the like. The inner core 131 may be integrally formed with the arm 300 by means of an integral milling.

The second connecting portion 130 and the arm 300 may also be connected by welding.

The second connecting portion 130 may also be detachably connected to the arm 300. After the spectacles 10 are used for a period of time, the arm 300 or the hinge assembly 100 need to be replaced due to wear or damage or the like. Due to the detachable connection between the second connecting portion 130 and the arm 300, the replacement of the arm 300 or the second connecting portion 130 is facilitated. Specifically, the second connecting portion 130 and the arm 300 may be connected by a snap connection, a screw connection, or the like.

The technical features of the embodiments described above can be arbitrarily combined. In order to make the description succinct, there is no describing of all possible combinations of the various technical features in the foregoing embodiments. It should be noted that there is no contradiction in the combination of these technical features which should be considered as the scope of the description.

Although the present disclosure is illustrated and described herein with reference to specific embodiments, the present disclosure is not intended to be limited to the details shown. It is to be noted that, various modifications may be made in the details within the scope and range of equivalents of the claims and without departing from the present disclosure. Therefore, the protection scope of the present disclosure shall be subject to the protection scope of the claims.

What is claimed is:

1. A hinge assembly, comprising:
a first connecting portion provided with a recessed structure,
a reinforcing portion at least partially covering an inner wall of the recessed structure,
wherein a strength of a material of the reinforcing portion is greater than a strength of a material of the first connecting portion, and
a second connecting portion inserted into the recessed structure and rotatable with respect to the first connecting portion.

2. The hinge assembly according to claim 1, wherein the reinforcing portion comprises a first portion, a second portion fixed to the first portion, and a third portion fixed to the first portion and opposite to the second portion; the first portion, the second portion, and the third portion cover the inner wall of the recessed structure, the first portion, the second portion, and the third portion cooperatively form a first groove, the second connecting portion is inserted into the first groove and adapted to the first groove, and the second connecting portion is rotatable with respect to the reinforcing portion about an axis of rotation perpendicular to a side wall of the first groove.

3. The hinge assembly according to claim 1, wherein the recessed structure is a through hole extending through the first connecting portion.

4. The hinge assembly according to claim 1, wherein the recessed structure is a groove on the first connecting portion.

5. The hinge assembly according to claim 1, wherein the recessed structure is provided with a first hole on the inner wall thereof, the reinforcing portion is provided with a second hole, the second connecting portion is provided with a third hole, and the first hole, the second hole, and the third hole are aligned; the hinge assembly further comprises a rotary connecting member engaged with the first hole, the second hole, and the third hole, respectively, such that the second connecting portion is rotatable about the rotary connecting member.

6. The hinge assembly according to claim 5, wherein the rotary connecting member is a threaded connecting member.

7. The hinge assembly according to claim 1, wherein the second connecting portion comprises an inner core and a coating layer covering the inner core, a strength of a material of the inner core is greater than a strength of a material of the coating layer.

8. The hinge assembly according to claim 1, wherein a strength of a material of the reinforcing portion is greater than a strength of a material of a surface of the second connecting portion.

9. Spectacles, comprising a frame, an arm, and a hinge assembly according to claim 1, the hinge assembly connecting the frame and the arm.

10. The spectacles according to claim 9, wherein the first connecting portion is integrally formed with the frame.

11. The spectacles according to claim 9, wherein the first connecting portion is detachably connected to the frame.

12. The spectacles according to claim 9, wherein the second connecting portion is provided with a receiving chamber, an end of the arm is located in the receiving chamber and an inner wall of the receiving chamber presses against the arm.

13. The spectacles according to claim 12, wherein the second connecting portion comprises an inner core and a coating layer covering the inner core, a strength of a material of the inner core is greater than a strength of a material of the coating layer, the receiving chamber is provided on the inner core, and the coating layer at least partially covers the arm.

14. The spectacles according to claim 12, wherein the receiving chamber is a through hole extending through the second connecting portion.

15. The spectacles according to claim 12, wherein the receiving chamber is a blind hole on second connecting portion.
